(19) United States
(12) Patent Application Publication
(10) Pub. No.: US 2005/0234877 A1
(43) Pub. Date: Oct. 20, 2005

(54) System and method for searching using a temporal dimension

(76) Inventor: Philip Shi-Lung Yu, Chappaqua, NY (US)

Correspondence Address: George A. Willinghan, III;Attorney-At-Law, Suite 350, 3201 New Mexico Avenue, NW, Washington, DC, 20016, US

(21) Appl. No.: 10/820,888

(22) Filed: Apr. 8, 2004

(51) Int. Cl. G06F 7/00

(52) U.S. Cl. 707/3

(57) ABSTRACT

The present invention is directed to a system and a method for generating a temporally ranked set of search results in response to a query. Each result in the set of search results can be ranked temporally or based on the reputation associated with authors of each result and the reputation associated with the repository where each result is located. Temporal ranking takes into account a present importance weight and a future importance weight are assigned to each result. The present importance of each result uses creation date, publication date, in-link dates and search frequency, and the future importance uses an aging factor based on the elapsed time from publication for each search result and a rate at which each search result decreases in importance. Temporal ranking can be applied as a modification of existing and common search engine algorithms include PageRank and HITS.

### FIELD OF THE INVENTION

The present invention relates generally to information queries and in particular to network-based search queries over internet websites and documents.

### BACKGROUND OF THE INVENTION

The impact and functionality of the Internet or World Wide Web for users as an information source can be attributed to the availability and success of Web search engines that permit users to find needed information easily. These search engines are used daily at both work and home. Search engine development has focused on locating the most relevant and quality information and website pages in response to a user query. The relevance and quality of a search result can be based on both the contents and the reputation of a given document or website. The content of a website or document, for example, refers to the objects or words that are actually contained within the pages of the site or paper. In the context of website pages, ranking the relevance of a website page includes determining how many of the query words are contained within a website page and how far these words are from each other in the page.

Typically a large number of search results are generated based on contents. Looking at the reputation of these results provides a method to rank the results so that the user can be provided with a ranked list of results. In the context of website page searching, for example, factors that are used to indicate a particular website page's reputation include the in-link count to a website page.

Various search engines and techniques have been developed to exploit both the contents and reputation of search results to yield ranked search results. One approach is known as the “PageRank” algorithm, examples of which are described in S. Brin and L. Page, The Anatomy of a Large-Scale Hypertextual Web Search Engine, Computer Networks and ISDN Systems, 30, 1998 and T. Haveliwala, Topic-Sensitive PageRank, WWW-2002. Another common approach is known as the “HITS” algorithm, examples of which are described in S. Chakrabarti, B. Dom, D. Gibson, J. Kleinberg, P. Raghavan and S. Rajagopalan, Automatic Resource Compilation by Analyzing Hyperlink Structure and Associated Text, WWW-1998 and J. Kleinberg, Authoritative Sources in a Hyperlinked Environment, ACM-SIAM Symposium on Discrete Algorithms, 1991. The entire disclosures of all four of these references are incorporated herein by reference. In general, these techniques take advantage of the observation that a hyperlink (or simply link for short) from one website page to a second website page is an implicit conveyance of authority or importance to the target website page. These algorithms identify important or quality pages, for example “authorities” and “hubs”, on the WWW by locating and examining the outgoing and incoming links, out-links and in-links, associated with various website pages. The authority scores and hub scores of website pages reflect the quality of each page as perceived by internet users or website page authors.

However, an important factor that is not considered by these techniques is the timeliness of search results. The WWW is a dynamic environment that changes constantly. Website pages that were perceived as being quality pages in the past may not be current or future quality pages.

In general, the timeliness or age of the contents of a search result is important because searchers or internet users are interested in the latest information. Apart from pages that contain well-established facts which do not change significantly over time, most contents in website pages or the state of scientific knowledge changes constantly and often rapidly. New pages or contents are added, and outdated contents and pages can be deleted or modified. Often, however, outdated pages and links are not deleted, causing problems for search engines that rank results based on contents and reputation, because these outdated pages can still be given a very high rank by these search engines.

In addition, existing website page search engines and scoring algorithms favor pages that have a large number of in-links, i.e. links into a given website page from other website pages. Therefore, these search engines also favor older pages, because the longer a website page exists, the more in-links it accumulates. Conversely, new pages and information, regardless of quality and timeliness of information will not be assigned high scores and will not be ranked high. Therefore, current search engines do not facilitate the location of the most up-to-date or latest information contained in databases or the internet. This problem is especially undesirable for researchers and analysts who are always interested in new results and techniques.

Therefore, a method and a search engine employing this method are needed to deal with the problems related to the temporal dimension of searching, which is of great importance to the future developments of search technology.

### SUMMARY OF THE INVENTION

The present invention is directed to a system and a method for generating a temporally ranked set of search results in response to a query. An initial set of search results is generated using reputation and content based factors including in-link count, the host reputation and author reputation. Then, a first portion of the initial search results having creation dates after a pre-determined threshold date is identified, and a second portion of the initial search results having creation dates before the pre-determined threshold date is identified. The second portion is ranked temporally, and the first portion of the initial search results are ranked based on the reputation associated with authors of each result and the reputation associated with the repository where each result is located.

In order to temporally rank the search results, a present importance weight and a future importance weight are assigned to each result. The present importance of each result uses creation date, publication date, in-link dates and search frequency, and the future importance uses an aging factor based on the elapsed time from publication for each search result and a rate at which each search result decreases in importance. For web-based data, the age or timing information can be located in meta content associated with each search result.

### BRIEF DESCRIPTION OF THE DRAWINGS

FIG. 1 is a flow chart illustrating an embodiment of the method in accordance with the present invention.

### DETAILED DESCRIPTION

The present invention is directed to methods and systems for conducting searches or queries of computer-based or network-based information. These methods and systems can be expressed as computer readable code and stored in a computer readable medium. As used herein, a search or query is any user defined, automated or auto-generated search for data or information. The query is conducted using, for example, a network-based or computer-based search engine. The data can be located in any electronic format or identified in an electronically readable catalogue, can be stored in main-frame, personal and portable computers, databases and computer readable storage mediums and can be accessed directly from the computer on which it is stored or across networks including local area networks, private area networks, secure area networks and wide area networks such as the world-wide-web (WWW) or internet. The data include website pages, publications or published papers and other information that are stored in databases or accessible across the internet.

In order to illustrate the relevant issues in greater detail, it is helpful to describe and to analyze different kinds of data or information, including website pages and published documents. For purposes of simplicity, data can be broadly classified into two types, old data and new data.

Old data are data that have existed for a significant period of time. In the case of website pages, old data are website pages that have appeared and been accessible over the internet for a significant period of time. Old data can be further classified as either quality data or common data. Quality data have a high reputation or reliability, as illustrated for example by a large number of in-links to a given website page or a given scientific paper. Quality data are data that searchers or users believe represent authoritative information or contain authoritative contents and are thus trustworthy. Common data lack reputation and reliability and, in the case of website pages, do not have many in-links.

The reliability of old quality data hinges on how often and reliably that data is updated. For up-to-date old data, the contents of the data reflect the latest and most reliable developments. These types of data maintain their quality status, reflected for example in the case of website pages and web based documents, by the fact that the data maintain old in-links and continue to accumulate new in-links over time. Since these data retained their value, suitable search and ranking techniques will associate high ranking scores with them.

Old quality data that are not up-to-date become outdated or cease to represent the state-of-the-art. This can be reflected by a decrease or cessation in the accumulation of new in-links over time as well as the deletion of old in-links. Often, however, old quality data that is not up-to-date is simply ignored while maintaining a sizeable number of in-links. While lacking in current value, these data would still be ranked very high by conventional search engines.

Old common data can also be classified into two distinct types based on time considerations. The first types are old common data that remain common data. The majority of common data remain common and do not see an increase in activity, interest or in-links. These data do not present a problem or significant concern for searching and ranking of results. The second type of old common data are old common data that increase in importance, reliability or value over time due to factors such as a change in fashion or the addition of higher quality contents. This rise in quality often results in an increase in reputation as evidenced by an increase in activity, interest or in-links over time that are associated with these data. The ranking assigned to these data by the search engines should also increase over time.

With regard to new data, these are data that have been recently generated, published or posted on the internet. New data can also be identified as either new quality data or new common data. New quality data while being of high quality and reliability have received relatively few or no interest or in-links because they are new. New common data are new and common in quality and reliability. Since new data, unlike old pages, receive few or no in-links, current search engines such as PageRank and HITS are not able to adequately judge the quality of these data.

Therefore, methods in accordance with the present invention utilize a temporal dimension or age factor in evaluating and ranking search results. These methods assign a lower importance to old quality data that are not up-to-date or are out of favor even though these data still have a sizeable number of associated links. In addition, the methods of the present invention assign a higher ranking to new quality data even though these data have yet to accumulate a significant amount of attention.

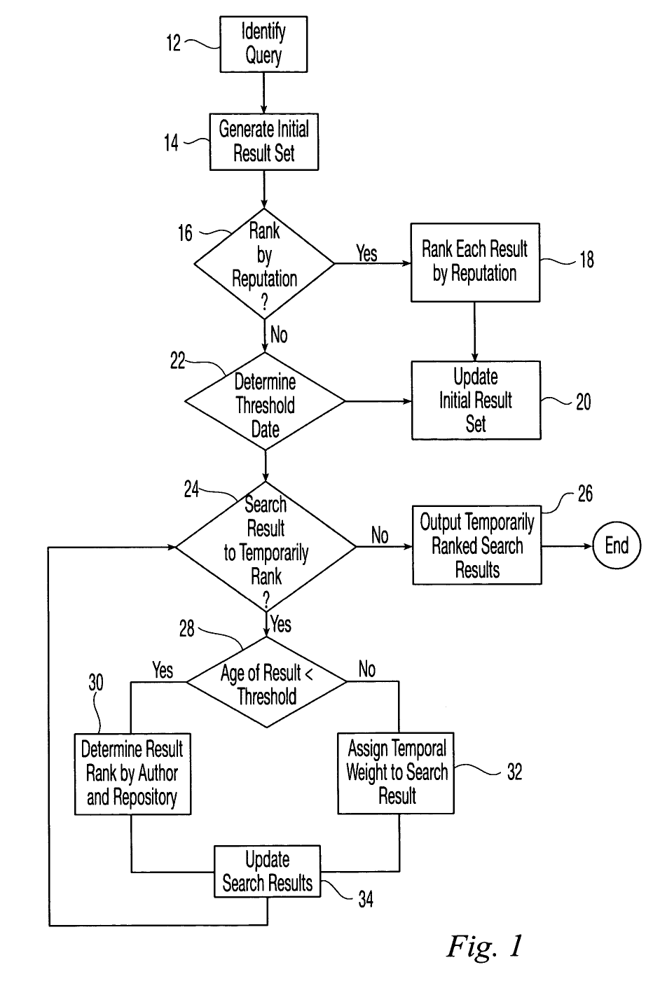

Referring to FIG. 1, a method 10 for searching data and generating a temporally ranked set of search results in response to a query in accordance with the present invention is illustrated. Initially, a query is identified 12. The query can be user-defined or auto-defined. The query is typically an alpha-numeric string containing a description of the information or data sought. Additionally, the query could contain symbols, pictures or any other information that can be used in a search. As was described before, the data being sought includes website pages, printed documents and papers and data contained in electronic databases. In general, the method of the present invention can be used to provide a ranked set of search results for any query over stored or catalogued data. In one embodiment as described herein, a method in accordance with the present invention is used to search for and rank website pages and the documents located in those pages. This embodiment is provided for purposes of illustrating a preferred embodiment of the present invention and is not intended to indicate that the present invention is only suitable for use with internet and web-based searches.

After the query has been identified, an initial set of search results are identified 14. This searching can be conducted using content based factors and reputation based factors. In one embodiment, for example when searching a single centralized database, the initial set of search results can be generated after the query is received by undertaking a complete review of the database. For multiple databases and internet searches, however, the computational time needed for searching is considerable and users typically want search results as quickly as possible. Therefore, in another embodiment, a program is run periodically, for example a web crawler, that searches the internet or database to identity new or updated data and to update the necessary linking information. After the crawling, the information obtained is updated and stored. Then in response to the query, this information can be searched and an initial set of search results provided quickly covering a very large amount of data.

The initial set of search results can be returned either ranked or unranked. In one embodiment, ranking by reputation or content based factors is undertaken during the pre-screaming or crawling process using algorithms known and available in the art. Suitable reputation based factors include in-link count, host reputation, author reputation and combinations thereof. In another embodiment, the initial search results are unranked. In this embodiment, a determination is made about whether or not to rank the initial set of search results by reputation 16. If yes, each one of the results is ranked 18, and the initial set of search results is updated accordingly 20. Suitable methods for ranking by reputation are known and available in the art and include the same methods as can be used during the crawling process. Ranking of the initial search results can be enhanced by also ranking them by content based factors. Also, the initial ranking by reputation can be used as an initial cut to remove those results that fall below a certain, pre-determined threshold of relevance. In general the process of ranking by reputation and updating the search results is an iterative process as the rank of the various results are dynamically interrelated.

In one embodiment, the query is searching for website pages or website based documents. In this embodiment, suitable reputation ranking algorithms for these types of searches include PageRank and HITS, examples of which were described above and incorporated by reference. In general, the PageRank (PR) score of website page A is:

$$PR ( A ) = ( 1 - d ) + d \times ( \frac{PR ( {p}_{1} )}{C ( {p}_{1} )} + … + \frac{PR ( {p}_{n} )}{C ( {p}_{n} )} ) \qquad ( 1 )$$

where

PR(A) is the PageRank score of page A,

PR(pᵢ) is the PageRank score of page pᵢ that links to page A,

C(pᵢ) is the number of outbound links of page pᵢ and

d is a damping factor which can be set to between 0 and 1.

Following ranking by reputation or in response to a decision not to rank the results by reputation, a determination is made about the threshold date for a given set of data 22. Beyond the threshold date the data are considered old, and before the threshold date the data are considered new. The threshold date will vary depending on the type of information being sought. Certain information, for example well established principles of science are stable over long periods of time. Other information, such as topics in popular culture or cutting edge research can change very rapidly over the course of only a few weeks or months.

Having generated, and if desired ranked, the initial set of search results, at least a portion of the initial set of search results is ranked based on temporal factors to generate the temporally ranked set of search results. Temporal ranking is performed iteratively on each result in the initial set of search results. Therefore, on each iteration, it is determined if any search results remain to be temporally ranked 24. If a search result remains to be temporally ranked, then the age of the search result is determined and compared to the threshold 28. In one embodiment for example, the present time is compared to the date that each result was created. If the difference is smaller than a given threshold, for example 3 months, that result is deemed to be new. If the difference is greater than the given threshold, the result is deemed to be old. Therefore, for an entire set of initial search results, a first portion of the initial search results is identified having creation dates after a pre-determined threshold date, and a second portion of the initial search results is identified having creation dates before the pre-determined threshold date. Preferably, only the second portion of the search results are ranked temporally.

In general, the age or date of a given result or datum, for example a website page, can be based on two main timing factors, the publication or creation date of the result and the dates on which the result is referenced or linked to by others, i.e., the dates that each in-link is created. In an embodiment where the search results include internet website pages and website pages have meta data associated with them that contain information such as the creation date or last modified date of the website, the meta data is used for temporal ranking in accordance with the present invention. In addition, the meta data include the name of the creator or author, the title and the topic. Therefore, meta data can also be used to provide information for content and reputation based searching and ranking.

If the age of the result is not less than the threshold, that is for results that are older than a pre-determined age, then that search result is ranked by assigning a temporal weight to the result 32, updating the results accordingly 34 and returning to check for additional results 24. In order to provide a temporal weight to each search result, a present importance weight and a future importance weight are assigned to each result in the initial set of search results that is to be temporally ranked. The present importance of each result is determined using creation date, publication date, in-link dates, search frequency and combinations thereof, and the future importance is determined using an aging factor based on the elapsed time from publication for each search result and a rate at which each search result decreases in importance.

In one embodiment, the PageRank algorithm is modified by adding a temporal dimension, which can be called the TimedPageRank. This method in accordance with the present invention takes into account both the present or current importance of a website page and the potential or projected importance of that website page in the future. Therefore, a hyperlink reference or in-link that is created within the last few months receives more weight or importance than a hyperlink reference or in-link that was created a year or two in the past. In one embodiment, the PageRank technique is modified by weighting each in-link that a website page receives based on the time that in-linking page was created to create the TimedPageRank technique. The time when a page is created is generally available in the HTML header of the website page. If not available, the time when the page is first discovered by the crawler can be used as an approximation of the website page creation time. For example, if the crawler crawls the internet repeatedly to discover new pages, a page's creation time will fall between the crawl that discovers the page and the previous crawl. In one embodiment, the time-weighted PageRank (PRT) value for each website page is defined as follows:

$${PR}^{T} ( A ) = ( 1 - d ) + d \times ( \frac{{w}_{1} \times {PR}^{T} ( {p}_{1} )}{C ( {p}_{1} )} + … + \frac{{w}_{n} \times {PR}^{T} ( {p}_{n} )}{C ( {p}_{n} )} ) \qquad ( 2 )$$

Equation (2) is a modified version of equation (1). In this equation, wᵢ is the time based weight for each in-link. Its value depends on the creation time or publication date of website page pᵢ. In one embodiment, smaller weights are assigned for earlier times. Any weighting policy can be used that adequately expresses the relationship between age and importance. In one embodiment, the weights are decayed exponentially according to time:
wᵢ=DecayRate^{(y-h)}

where y is the current time, tᵢ is the time of publication of page pᵢ and (y−tᵢ) is the time gap. DecayRate is a parameter that can be pre-determined and set by the administrator of the search engine based upon the type of data being searched. In addition, the DecayRate parameter can be tuned or learned experimentally according to the nature of a website page or website or topic. When its value is close to 1, the weight decreases slowly with time, which is more suitable for static domains or topics. Conversely, if its value is close to 0, the weight decreases rapidly with time, which is more suitable for dynamic domains. In one embodiment, a default value of 0.5 is used. In another embodiment, DecayRate is chosen experimentally by splitting the website pages into two groups. One group, called the N group, contains the pages created within the most recent period of length t (say t=1 year). The other group, called the O group, contains the remaining pages. Each DecayRate chosen will imply a ranking of the website pages for the O group. A second ranking is then determined based on the number of in-links each website in the O group received from the N group. The references or in-links from the N group represent the current interest to each website page in the O group. The difference between the two rankings over all pages in the O group is calculated to reflect the goodness of the TimedPageRank. The DecayRate that minimizes the rank differences will be chosen.

Various extensions and alternatives exist. For example, in one embodiment the O group can be taken and evaluated for each website separately. In this embodiment, a different DecayRate is obtained for the in-links from each website separately. In another embodiment, this is accomplished by topic instead of website.

Using in-links for temporally weighting focuses on events from the past. It is also desirable to look at the potential importance of data in the future, e.g., what is the likely importance or impact of the data or information in the future. In one embodiment, future importance can be evaluated by taking into account the publication date of data.

Even though two website pages may both be older than the threshold age, the website page that was created later in time and that is newer is more likely to be of interest than the older of the two. Therefore, another parameter, called the aging factor and designated Aging(A), is used. In one embodiment the value of Aging(A) is in [0, 1]. Therefore the final TimedPageRank (TPR) for a given result A is computed as follows:
TPR(A)=Aging(A)*PR^{T}(A) (3)

where PR^{T}(A) is computed using equation (2). The aging factor can be tuned or learned for a given page. In one embodiment a regression technique is used to learn the aging factor of pages on a website. For example, to compute Aging(A), website pages are partition according to ages, and the average click rate to each age group in a recent period, for example within the last week, is computed. The click rate to each website page can be tracked by each website from the Web log. Linear regression techniques are then used to predict click rate based on the age of a website page. In addition, the predicted click rate value can be normalized by its maximum value, and the normalized click rate can be used as the aging factor. Various extensions and alternatives to the present invention for expressing the aging factor can be used and are within the spirit and scope off the present invention.

Although TimedPageRank is able to consider time, it is not as useful for new result, for example results that were just published recently, since these results have few or no in-links. Referring again to FIG. 1, if the age of the result is less than the threshold, the search result is ranked by the reputation of the author, the reputation of the repository where the result was found or both 30 since these new results are unlikely to have substantial amounts of linking information. TimedPageRank can be utilized, however, to compute these two reputations.

In one embodiment, the reputation of a website is based on the pages that appeared in the site in the past. A score, WebsitelEval(j), is assigned to each Web site j. Let the website pages that the website wⱼ publishes in the past be p₁, p₂, . . . , pₙ, the website score is computed as follows:

$$Wbsite ( {w}_{j} ) = \frac{{\sum }_{i = 1}^{n} {PR}^{T} ( {p}_{i} )}{n}$$

where PR^{T}(pᵢ) is the time-weighted PageRank score of page pᵢ. Here PR^{T}(pᵢ) is used rather than PR(pᵢ) as more recent in-links are considered more representative of the current reputation of the website. Various extensions to the present invention can be used within the spirit and scope thereof. For example, a higher weight can be given to more recent pages of the website. One approach is to use TPR(pᵢ) instead of PR^{T}(pᵢ).

In one embodiment where the search results include website pages and web-based documents, the reputation of the author is determined by averaging the time-weighted PageRank values of all of the author's past pages. For example, let the website pages that the author aⱼ creates in the past be p₁, p₂, . . . , pₘ, the author score (Author) is computed as follows:

$$Author ( {a}_{j} ) = \frac{{\sum }_{i = 1}^{m} {PR}^{T} ( {p}_{i} )}{m}$$

Using the Web site and author evaluations, the importance of each newly created website page can be evaluated. Note that for an author who has never published a page before, a reputation would not be available.

In another embodiment, the website score can be calculated as the average score of its website pages.

In another embodiment, the author score is used as the score of the website page. If there is more than one author, an average over the authors can be used. Clearly, there are many other ways for the computation, e.g., maximum or weighted average based on the order of the authorship.

In addition, the website evaluation and author evaluation can be combined to score each website page. Assume that website page p is published in website wⱼ. The combined score is computed as follows:
WAEval(p)=(Website(wj)+Author(p))/2 (4)

Again, there are many other ways for the combination. One alternative is to calculate the Website(w) and Author(p) score based on each topic, separately.

In general, after a website page has been published for a while, it is more effective to use TimedPageRank to score the website page. Website and author evaluations are less effective. This makes sense because after a website page is published for a while, its in-link counts reflect the impact or importance of the website page better than its website and author.

As each result that is deemed new is ranked, the entire set of search results is update accordingly 34, and the set of search results is again checked for results that have not been temporally ranked 24. Once there are no longer search results remaining to be temporally ranked, the temporally ranked search results are outputted to the user 26 and the process ends.

The present invention can also be used to provide a service offering that generates a temporally ranked set of search results in response to customer query. For example, any company can acquire such a service for its intranet (i.e., internal Web site) to help employees find useful information or for its extranet for customers to search for useful information on its site. Even a search engine site can use such a service to help rank its search results. The search service will incorporate the methods in accordance with the present invention to rank search results taking into consideration the temporal dimension. In one embodiment, the search service can be modified or customized in accordance with input from the customers regarding various parameters covering the type of service that the customer wants to receive and also covering the type of the search desired and the temporal ranking preferences.

Customization and variance of the parameters can be a function of and dependent upon the topic that is being search, the repository (database, website or website page) being searched or both. Therefore, the threshold limits established and the temporally weighting assigned to the search results can be varied based upon an understanding of the rate at which the information changes. More stable sites and topics would dictate longer threshold times, one or more years, and more even temporal weighting. Topics and sites that change rapidly would dictate relatively short threshold times, months or weeks, and significantly less temporal weighting to older search results. In addition, more stable results would require a linear increase of moderate slope in the temporal weighting with age. Rapidly changing sites and topics might require and exponential increase in the temporal weighting with age.

Customization is not limited to the methods used to temporally rank the search results but can be provided for parameters related to all aspects of the service. For example, the service can allow the customer to affect the rate at which old data, such as the old in-links or old pages, should be phased out. Furthermore, the customer can have direct input on the Decay rate selection or specify the half life (i.e., the period the wᵢ in (2) drops to 0.5.) Customers can also select among the alternative reputation raking techniques offered by the service regarding how the website or author evaluation are done, e.g. whether it should be topic specific. The service can also allow the customer to apply multiple criteria on the temporal dimension and provide separate ranking lists based on each of these criteria. Other customizable features of the search service include the format in which the results are presented, the breadth of the search, the number of times the service is provided (one time service or repeat service), and whether the service is provided over the internet in a web-based environment or as a customized on-site service. In addition, the service can be combined with other services, such as portal service.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

1. A method for searching data comprising:
generating a temporally ranked set of search results in response to a query, the step of generating a temporally the temporally ranked set of search results comprising:
generating an initial set of search results; and
ranking at least a portion of the initial set of search results based on temporal factors to generate the temporally ranked set of search results.

2. The method of claim 1, wherein the step of generating the initial set of search results comprises using reputation based factors or content based factors.

3. The method of claim 1, wherein the step of ranking the initial search results comprises assigning a present importance weight and a future importance weight to each result in the initial set of search results.

4. The method of claim 3, further comprising:
determining the present importance of each result using creation date, publication date, in-link dates, search frequency or combinations thereof; and
determining the future importance using an aging factor based on the elapsed time from publication for each search result and a rate at which each search result decreases in importance.

5. The method of claim 1, wherein the data being searched comprises web-based data and the method further comprises obtaining time and date information about each search result from meta content associated with the search result.

6. The method of claim 1, further comprising:
identifying a first portion of the initial search results having creation dates after a pre-determined threshold date; and
identifying a second portion of the initial search results having creation dates before the pre-determined threshold date;
wherein the step of ranking at least a portion of the search results comprises ranking the second portion.

7. The method of claim 6, further comprising ranking the first portion of the initial search results based on a reputation associated with authors of each result, a reputation associated with a repository where each result is located or a combination of author and repository reputation.

8. The method of claim 1, further comprising ranking the initial set of search results based upon the reputation or content of each result.

9. A computer readable medium containing a computer executable code that when read by a computer causes the computer to perform a method for searching data comprising generating a temporally ranked set of search results in response to a query, said step of generating a temporally ranked set of search results comprising:
generating an initial set of search results; and
ranking at least a portion of the initial set of search results based on temporal factors to generate the temporally ranked set of search results.

10. The computer readable medium of claim 9, wherein the step of ranking the initial search results comprises assigning a present importance weight and a future importance weight to each result in the initial set of search results.

11. The computer readable medium of claim 10, further comprising:
determining the present importance of each result using creation date, publication date, in-link dates, search frequency or combinations thereof; and
determining the future importance using an aging factor based on the elapsed time from publication for each search result and a rate at which each search result decreases in importance.

12. The computer readable medium of claim 9, wherein the data being search comprises web-based data and the method further comprises obtaining time and date information about each search result from meta content associated with the search result.

13. The computer readable medium of claim 9, further comprising:
identifying a first portion of the initial search results having creation dates after a pre-determined threshold date; and
identifying a second portion of the initial search results having creation dates before the pre-determined threshold date;
wherein the step of ranking at least a portion of the search results comprises ranking the second portion.

14. The computer readable medium of claim 10, further comprising ranking the first portion of the initial search results based on a reputation associated with authors of each result, a reputation associated with a repository where each result is located or a combination of author and repository reputation.

15. A method comprising:
offering a service to customers that generates a temporally ranked set of search results in response to a query; and
modifying one or more parameters of the service in response to customer input.

16. The method of claim 15, wherein the parameters comprise rate of phase-out of old data, decay rate, temporal criteria, reputation ranking techniques or combinations thereof.

17. The method of claim 15, wherein further comprising modifying the parameters based upon the topic or repository being searched.
